(19) United States
(12) Patent Application Publication
(10) Pub. No.: US 2005/0281467 A1
(43) Pub. Date: Dec. 22, 2005

(54) Recognizing multi-stroke symbols

(76) Inventor: Thomas F. Stahovich, Riverside, CA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 11/138,577

(22) Filed: May 26, 2005

Related U.S. Application Data
(63) Continuation-in-part of application No. 10/350,952, filed on Jan. 24, 2003.

(51) Int. Cl. G06K 9/46

(52) U.S. Cl. 382/202

(57) ABSTRACT

A method of analyzing a symbol comprised of one or more drawn strokes is comprised of calculating the speed of drawing along each stroke. A curvature magnitude along each stroke is calculated. An initial set of candidate points defining initial segments is identified using the calculated speed and curvature metric magnitude. The initial segments are classified as a type of primitive. The initial segments are compared to the original stroke. Merging and splitting of certain of the initial segments may be performed in response to the comparison to produce new segments which are classified as a type of primitive. Because of the rules governing abstracts, this abstract should not be used in construing the claims.

This application claims the benefit under 35 U.S.C. §119(e) of provisional application Ser. No. 60/352,325 entitled Recognizing Multi-Stroke Symbols filed on Jan. 28, 2002, which is incorporated herein by reference, and claims priority from co-pending U.S. patent application Ser. No. 10/350,952 filed on Jan. 24, 2003 and entitled Recognizing Multi-Stroke Symbols.

### STATEMENT REGARDING FEDERALLY SPONSORED RESEARCH

This application was funded in part under NSF contract no. DMI 0200262. The government may have rights in this invention.

### BACKGROUND OF THE INVENTION

The present invention is directed generally to machine learning techniques and, more particularly, to machine learning techniques for recognizing sketched symbols and shapes for use in a sketch based user interface.

Despite the power and sophistication of modern engineering design tools, engineers often avoid using such tools until late in the design process. Instead, it is common for engineers to do much of their early design work on paper, using sketches extensively. After the major design issues have been resolved, the sketched designs are then recreated on the computer to take advantage of the capabilities of design software. The problem here, we believe, is the cumbersomeness of traditional user interfaces. When designs are in flux, the inconvenience of such user interfaces places too much overhead on the creative process.

In our research, we are working to change that by creating user interfaces that allow users to operate software by means of familiar sketching skills. The ultimate goal is to create software that is as easy to use as paper and pencil, yet is as powerful as traditional software. Rather than the user having to learn how to use software, software should be able to read, understand, and use the kinds of sketches people ordinarily draw. For example, an engineer should be able operate a mechanical simulation tool by drawing the kinds of simple sketches that he or she would draw when solving problems by hand.

In attempting to reproduce the ease and freedom of sketches on the computer, care must taken to avoid placing new constraints on the drawing process. For example, some existing sketch-based systems require that each pen stroke represent a single shape, such as a single line or arc segment. Rui Zhao, “Incremental recognition in gesture-based and syntax directed diagram editor,” Proceedings of InterCHI'93; pages 95-100, 1993; T. Igarashi, S. Matsuoka, S. Kawachiya, and H. Tanaka, “Interactive beautification: A technique for rapid geometric design,” UIST '97, pages 105-114, 1997; L. Eggli, “Sketching with constraints,” Master's thesis, University of Utah, 1994; R. Zeleznik et al., “Sketch: An interface for sketching 3D scenes,” Proceedings of SIGGRAPH'96, pages 163-170, 1996; M. Shpitalni and H. Lipson, “Classification of sketch strokes and corner detection using conic sections and adaptive clustering,” ASME Journal of Mechanical Design, 119(2): 131-135, 1996. Other systems allow pen strokes to have more complicated shapes, but each stroke must constitute a single symbol or gesture. Dean Rubine, “Specifying gestures by example,” Computer Graphics, 25:329-337, July 1991; Manuel J. Fonseca and Joaquim A. Jorge, “Using Fuzzy Logic to Recognize Geometric shapes Interactively,” Proceedings of the 9^{th}Int. Conference on Fuzzy Systems (FUZZ-IEEE 2000), San Antonio, USA, May 2000; James A. Landay and Brad A. Myers, “Sketching interfaces: Toward more human interface design,” IEEE Computer, 34(3):56-64, 2001. While these kinds of constraints on drawing facilitate shape recognition, they can result in a less than natural drawing environment.

The challenge in segmenting a pen stroke into its constituent geometric primitives is deciding which bumps and bends are intended, and which are accidents. We have found it difficult to determine this by considering shape alone. The size of the deviation from an ideal line or arc is not a reliable indicator of what was intended: sometimes small deviations are intended while other times large ones are accidents.

Segmentation of pen strokes is similar to the problem of corner detection in digital curves, a field which has attracted the efforts of numerous researchers. Corner detection algorithms typically locate corners by searching for points at which curvature is a maximum. To suppress noise and false corners, the data must be smoothed. The main difficulty is selecting a reliable “observation scale” or amount of smoothing. Too little smoothing leads to superfluous corners whereas excessive smoothing causes the disappearance of true corners. Early approaches (see C. H. Teh and R. T. Chin, “On the detection of dominant points on digital curves,” IEEE Transactions on Pattern Analysis and Machine Intelligence, 11(8):859-872, 1989 for an overview) relied on a single scale, which created difficulties for curves containing both large and small features.

Later work has addressed the problem of individual curves containing features at various scales. For example, A. Rattarangsi and R. T. Chin, “Scale-based detection of corners of planar curves,” IEEE Transactions on Pattern Analysis and Machine Intelligence, 14(4):430-339, April 1992, developed a scale-space approach for corner detection. A digital gaussian filter is repeatedly applied to the curvature data, and the maxima of curvature are identified for each scale. Curvature maxima that persist across multiple scales indicate corner points. Although the method can find features at multiple scales, it is still necessary to define the range of scales to be considered. Also, the approach produces false corners when there is quantization error. For example, corner points are often found on accurate digital circles. Jiann-Shu Lee, Yung-Nien Sun, and Chin-Hsing Chen, “Multiscale corner detection by using wavelet transform,” IEEE Transactions on Image Processing, 4(1):100-104, 1995, developed a multi-scale corner detection algorithm based on the wavelet transform. That approach produces fewer false corners than Rattarangsi and Chin's, and is less computationally expensive. Sezgin has applied a multi-scale approach to sketches and found that curvature data alone is not adequate for segmenting hand drawn pen strokes.

Recently, Yu, “Recognition of Freehand Sketches Using Mean Shift,” International Conference on Intelligent User Interfaces, IUI'03, 2003, has applied a curvature based method to the problem of segmenting hand drawn pen strokes. The method is based on a “mean shift” technique in which the curvature and tangent angle are iteratively smoothed based on neighboring values of both the curvature and tangent angle. The resulting segmentation is compared to the original ink, and if the fit is not precise, the stroke is recursively subdivided until a precise fit is achieved. In our work, we have found that a precise fit to the raw ink is often not what the drawer intended. Sketches, by their very nature, are imprecise. Our goal is to match the drawer's intent despite the imprecision of the drawing. Our experiments have suggested that speed information is often indicative of intent.

The earliest report of using pen speed for segmenting that we have been able to find is the work of Christopher F. Herot, “Graphical input through machine recognition of sketches,” Proceedings of the 3^{rd} annual conference on Computer graphics and interactive techniques, pages 97-102, ACM Press, 1976. His system found corners by identifying points at which pen speed was a minimum. The author reported that the system did not work well for all users and he concluded that the program contained a “model of human sketching behavior that fit some users more closely than others.” T. Sezgin, T. Stahovich and R. Davis presented a technique, “Sketch based interfaces: Early processing for sketch understanding,” Proceedings of the 2001 Perceptive User Interfaces workshop (PUI'01), 2001, that used speed and curvature to segment hand drawn pen strokes. Segment points were located at points of minimal speed and maximal curvature. This work demonstrated the usefulness of speed data for segmenting and demonstrated that curvature data alone is inadequate. The technique is suitable for segmenting pen strokes into sequences of line segments, but the technique cannot handle arcs. Curved regions of the pen stroke are not segmented, but rather are represented by b-splines. The approach presented here can handle pen strokes consisting of both lines and arcs. Much of the challenge in the current work has to do with handling arcs. Also, the technique in “Sketch based interfaces: Early processing for sketch understanding,” supra, iteratively adds segment points until the error of fit between the line segments and raw ink is less than a threshold.

As a variant of the approach in “Sketch based interfaces: Early processing for sketch understanding,” supra, Sezgin explored the use of multi-scale methods for selecting speed minima and curvature maxima. Tevfik Metin Sezgin, “Feature point detection and curve approximation for early processing of free-hand sketches,” Master's thesis, Massachusetts Institute of Technology, 2001. However, he found that unless the pen strokes were exceptionally noisy, there was little benefit in doing so.

Peter Agar and Kevin Novins, “Polygon recognition in sketch-based interfaces with immediate and continuous feedback,” Proceedings of the 1^{st} international conference on Computer graphics and interactive techniques in Australia and South East Asia, pages 147-150, ACM Press, 2003, have developed a segmenter for polygons. The system identifies segment points while a polygon is drawn, and provides immediate feedback to the user. The approach is based on examining the time interval between mouse movement events. If the mouse is stationary for more than thirty msecs, the location is taken to be a segment point. This approach is analogous to our pen speed approach. However, because it requires that the mouse be paused at each corner, the approach is likely to work well only at very sharp corners. Additionally, the approach can handle only line segments and not arcs.

All of the approaches described so far operate by locating segment points first, and then defining the segments between them. G. Dudek and J. Tsotsos, “Shape representation and recognition from multiscale curvature,” CVIU, 68(2):170-189, 1997, have turned the problem around by first looking for the segments. Their approach is called “curvature-tuned smoothing.” The method uses energy minimization to compute an approximation curve that best matches the input curve while at the same time attempting to maintain a desired curvature. If an approximation with sufficiently low energy cannot be found, the approximation curve is subdivided and the process is iterated. This process can be performed with different values of the desired curvature to find regions of the input curve that have various curvatures. Each such region constitutes a segment. A given data point in the input curve may belong to different segments having different values of the curvature, resulting in overlapping segments.

Thus, the need exists for a method and apparatus for recognizing sketched symbols that overcomes the problems inherent in the prior art.

### BRIEF SUMMARY OF THE INVENTION

The work presented here concerns the low level processing of pen strokes necessary to overcome some of the kinds of constraints found in the prior art. In particular, we present an approach for automatically segmenting pen strokes into the intended geometric primitives. Our approach enables one to draw a shape with as few or as many stokes as desired. For example, one can draw a triangle with one, two, or three pen strokes. Likewise, it enables one to include parts of different shapes or symbols in the same pen stroke.

Our approach to segmentation relies on examining the motion of the pen tip as the pen strokes are created. We have observed that it is natural to slow the pen when making many kinds of intentional discontinuities in the shape. For example, although a square may not be drawn as four precise lines, the intended corners can be easily identified as points at which the speed is a local minimum.

Our segmenter's first task is to examine the pen stroke to identify the segment points, the points that divide the stroke into different primitives. The initial set of candidate segment points includes speed minima below a threshold, where the threshold is computed from the average pen speed. Points at which curvature is a maximum are also included, but only if there is corroborating pen speed information. The ink between each pair of consecutive segment points is referred to as a segment. Each such segment is classified as line or arc, depending upon which best fits the ink. Although the initial segmentation is reasonably accurate, feedback can be used to improve the accuracy. During the feedback process, the initial segmentation is examined, and segments are merged and split as necessary to correct any detected problems. The disclosed segmenter can serve as a foundation to build sketch understanding systems.

### BRIEF DESCRIPTION OF THE DRAWINGS

For the present invention to be easily understood and readily practiced, the present invention will now be described, for purposes of illustration and not limitation, in conjunction with the following figures, wherein:

FIG. 1 illustrates typical symbols; basic shapes include a line, arc, triangle, square, and pie slice; mechanical objects include a pulley and ropes, pivot, spring, and beam;

FIG. 2(a) illustrates a raw pen stroke, FIG. 2(b) an interpretation as a single line and FIG. 2(c) an interpretation as three lines;

FIG. 3(a) illustrates a raw pen stroke, FIG. 3(b) an interpretation as two lines and FIG. 3(c) an interpretation as an arc;

FIG. 4 illustrates a square drawn using a stylus and the associated pen tip speed profile; the corners are identifiable by the low speed;

FIG. 5 illustrates the segment points for thresholds of (a) 20% (b) 25% and (c) 35% of the average pen speed;

FIG. 6 illustrates the calculation of the curvature sign using a window having nine points;

FIG. 7 illustrates the segment points for curvature window sizes of (a) 30 (b) 15 and (c) 10 points (Note that speed segment points are not shown);

FIG. 8 illustrates the saturating error function for continuous valued properties;

FIG. 9 illustrates exemplary hardware on which the present invention may be practiced;

FIG. 10 is curvature data from a square. A: Curvature based on tangent angle. B: Curvature data computed with equation 6. C: Data from B after five applications of Gaussian filter. D: Data from B after ten applications of Gaussian filter;

FIG. 11 is a hand drawn pivot symbol with A showing the raw ink, B showing segmented ink and C showing raw and segmented ink overlayed;

FIG. 12 illustrates pen speed normalized by the average speed for the pivot in FIG. 11. Intended segment points are indicated by circles;

FIG. 13 illustrates the ink curvature for the pivot of FIG. 11;

FIG. 14A illustrates the candidate segment points for an “s-curve” (circle=speed segment point, square=curvature magnitude segment point, triangle=curvature sign segment point) and FIG. 14B illustrates the final segmentation;

FIG. 15A illustrates the candidate segment points for a square wave (circle=speed segment point, square=curvature magnitude segment point, triangle=curvature sign segment point) and FIG. 15B illustrates the final segmentation;

FIG. 16A illustrates a set of ten shapes drawn approximately 3 cm in size in a user study; A illustrates the raw ink; B illustrates the segmented ink using a low resolution mode and speed threshold of 25%;

FIG. 17A illustrates a set of ten shapes drawn approximately 1 cm in size in a user study; A illustrates the raw ink; B illustrates the segmented ink using a high resolution mode and speed threshold of 85%;

FIG. 18 illustrates the AC-SPARC system;

FIG. 19 illustrates the intersection types used in a feature-based recognizer; and

FIG. 20 illustrates electric circuit symbols.

### DETAILED DESCRIPTION OF THE INVENTION

Pen Stroke Segmenting

The first step in interpreting a sketch is processing the individual pen strokes to determine what shapes they represent. Much of the previous work in this area assumes that each pen stroke represents a single shape, such as a single line segment or arc segment, which ever fits the stroke best. While this kind of approach facilitates shape recognition, it results in a less than natural user interface. For example, one would be forced to draw a square as four individual pen strokes, rather than a single pen stroke with three 90° bends.

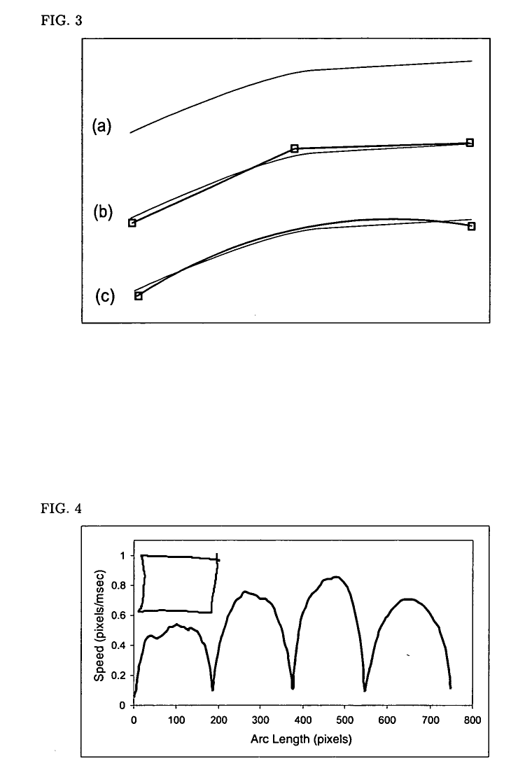

Our invention facilitates a natural sketch interface by allowing pen strokes to represent any number of shape primitives connected together. This requires examining each stroke to identify the segment points, the points that divide the stroke into different primitives. The key challenge is determining which bumps and bends are intended and which are accidents. Consider, the pen stroke in FIG. 2(a), for example. Was this intended to be a single straight line as in FIG. 2(b), or three straight lines as in FIG. 2(c)? Similarly, was the pen stroke in FIG. 3(a) intended to be two straight lines forming a corner as in FIG. 3(b), or was it intended to be a segment of an arc as in FIG. 3(c)? We have found it difficult to answer these sorts of question by considering shape alone. The size of the deviation from an ideal line or arc is not a reliable indicator of what was intended: sometimes small deviations are intended while other times large ones are accidents.

Our approach to this problem relies on examining the motion of the pen tip as the strokes are created. We have discovered that it is natural to slow the pen when making many kinds of intentional discontinuities in the shape. For example, if the stroke in FIG. 3(a) was intended to be two lines forming a corner, the drawer would likely have slowed down when making the corner. Similarly, when drawing a rectangle as a single pen stroke, it is natural to slow down at the corners, which are the three segment points. FIG. 4 shows the speed profile for a typical square. The corners can be easily identified by the low pen speed.

Pen speed can be calculated in a number of ways. In our method, pen speed is calculated as the distance traveled between consecutive pen samples divided by the time elapsed between the samples. Distance is measured in the hardware coordinates of the input device. Because most pen input devices emulate a mouse, we have written our software to use a standard mouse programming interface. (We have written another version of our software that uses the standard programming interface for standard digitizing pad and stylus systems.) This has allowed us to use our software with an electronic white-board, a stylus and digitizing pad, and a conventional mouse. We initially used an event-driven software model, but found that the temporal resolution was inadequate on some platforms. Our current approach is to use the event-driven model to handle pen up and pen down events, and to poll for the mouse position in between. This has allowed us to increase the resolution, but it does result in redundant samples when the mouse is stationary. When the mouse is stationary, there is a sequence of samples that all have zero velocity. We discard all but the first sample in these sequences.

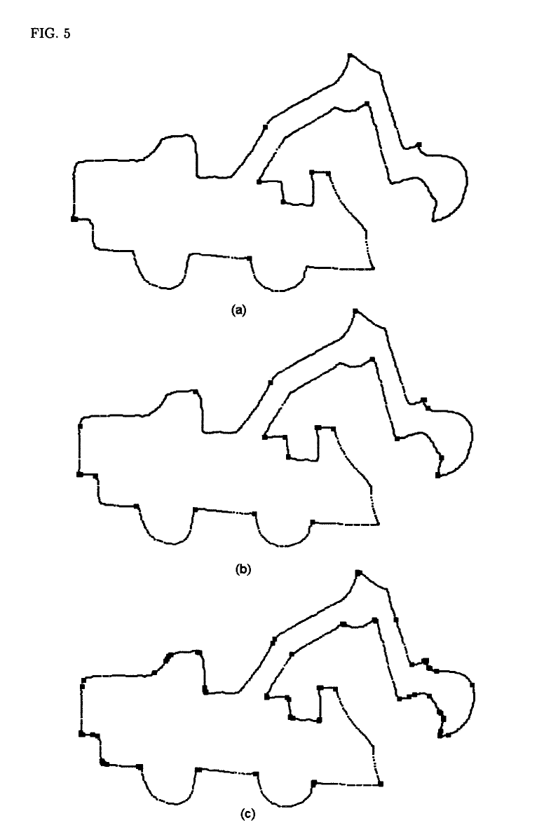

Once the pen speed has been calculated at each point along the stroke, segment points can be found by thresholding the speed. Any point that is a local speed minimum, and has a speed below the threshold is a segment point. We specify the threshold as fraction of the average speed along the particular pen stroke. If necessary, the user can adjust the threshold to match his or her particular drawing style. In our informal testing, we have found that with a small amount of tuning, one can achieve good results. FIG. 5 shows the segment points that are detected for a typical pen stroke for various values of a fixed threshold. To enhance the performance of this approach, one can slightly exaggerate the slowdown at intended segments points. The drawing experience is still natural because no pen up and pen down events are necessary, and there is no need to stop completely.

While many intentional discontinuities occur at low pen speed, others do not. For example, when drawing an “S” shape, there may not be a reduction in pen speed at the transition from one lobe to the other. We can locate these kinds of segment points by examining the curvature of the pen stroke. Segment points occur at locations where the curvature changes sign. We consider three distinct signs: positive, negative, and zero. When computing the sign, we examine a window of points on either side of the point in question. We connect the first and last points in the window with a line segment. We then calculate the minimum distance from each point in the window to the line. Distances to the left of the line are positive, while those to the right are negative. Left and right are defined relative to the drawing direction. The signed distances are summed to determine the sign of the curvature. If the absolute value of the sum is less than a threshold, the curvature is considered to be zero. In the example in FIG. 6, the curvature is positive because there are more positive distances than negative ones. (In this example, the drawing direction is from left to right.)

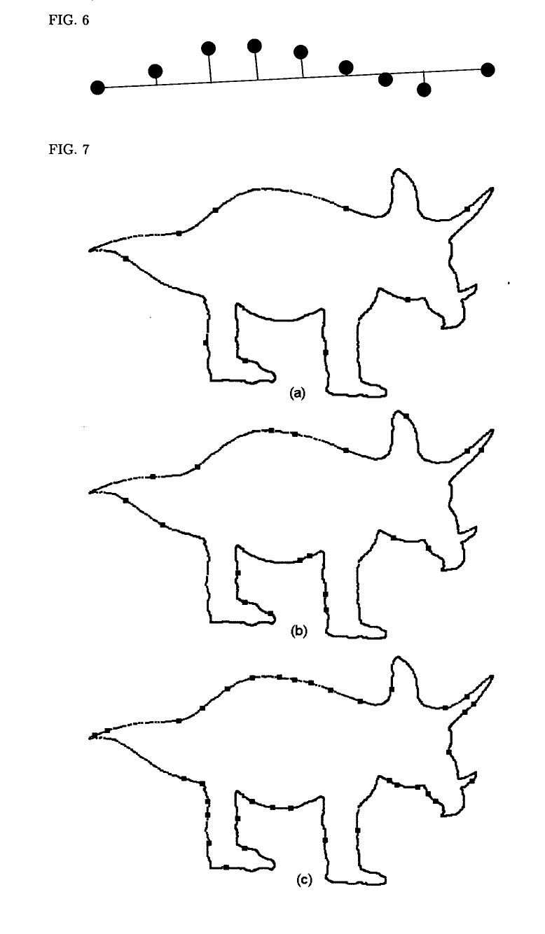

By using a window of points to compute the sign of the curvature, we are able to smooth out noise in the pen signal. Some of the noise comes from minor fluctuations in the drawing, other noise comes from the digitizing error of the input device. The larger the window, the larger the smoothing effect. The size of the window must be tuned to the input device and the user. For mouse input, we have found a window size of between 10 and 30 points to be suitable. FIG. 7 shows how the number of segment points varies with the window size.

Once the strokes have been segmented, the next task is to determine which segments represent lines and which represent circular arcs or other types of geometric primitives. We compute the least squares best fit line and arc for each segment. The segment is typically classified by the shape that matches with the least error. However, nearly straight lines can always be fit with high accuracy by an arc with a very large radius. In such cases, we use a threshold to determine if a segment should be an arc or a line. To be an arc, the arc length must be at least 15°. Other techniques and thresholds may be used.

Symbol Recognition: Training (Learning and Storing Definitions)

After segmenting the pen strokes, the next step is to recognize individual symbols. We have developed a trainable symbol recognizer for this purpose. Our approach is similar to near miss learning, except that currently we consider only positive training examples. To train the system, the user provides several examples of a given symbol. Each example is characterized by a semantic network description. The networks for the various examples are compared, and any sketch properties (network links) that occur frequently are assembled to form a definition of the symbol. This definition is a generalization of the examples, and is useful for recognizing other examples of the symbol.

The objects in the semantic network are geometric primitives: e.g. line and arc segments. The links in the network are geometric relationships between the primitives. These may include (among others):

The existence of intersections between primitives.

The relative location of intersections.

The angle between intersecting lines.

The existence of parallel lines.

In addition to the relationships, each primitive is characterized by (intrinsic) properties, including:

Type: line or arc.

Length.

Relative length.

We describe distance by both an absolute and relative metric. An absolute distance is measured in pixels, or other hardware dependent unit of measure. Relative distances are measured as a proportion of the total of all of the stroke lengths in the symbol. For example, the relative length of one side of a perfect square is 25%.

Using absolute distance metrics allows the program to learn definitions in which size matters, while relative distances ignore uniform scaling. For example, if the training examples are squares of different sizes, the definition will be based on relative length and thus will be suitable for recognizing squares of all sizes. If, on the other hand, all of the training examples are squares of the same size, the definition will be based on absolute distance, and only squares of that size will be recognized. In this particular case, all of the examples will also have similar relative lengths, and thus the definition will also include requirements on relative length. However, those requirements will be redundant with those on absolute length.

The locations of intersections between primitives are measured relative to the lengths of the primitives. For example, if the beginning of one line segment intersects the middle of another, the intersection is described as the point (0%, 50%). When extracting intersections from the sketch, a tolerance is used to allow for cases in which an intersection was intended, but one of the primitives was a little too short. The tolerance zone at each end of the primitive may be, for example, 25% of the length of that primitive. If an intersection occurs in the tolerance zone, it is recorded as being at the end of the primitive: The relative location is described as 0% if the intersection is near the beginning of the segment, or 100% if it is near the end.

If a pair of lines do not intersect, the program checks if they are parallel. Here again, a tolerance is used because of the imprecise nature of a sketch. Two lines are considered to be parallel if their slopes differ by no more than, for example, 5°.

To construct the definition of a symbol, the semantic networks for each of the symbols are compared to identify common attributes. If a binary attribute, such as the existence of an intersection, occurs with a frequency greater than a particular threshold, that attribute is included in the definition. Similarly, if an attribute has a continuous numerical value, such as relative length, it will be included in the definition if its standard deviation is less than some threshold.

The thresholds are empirically determined, and the values are as follows. The occurrence frequency threshold for intersections may be, for example, 70%. That is, if at least 70% of the training examples have an intersection between a particular pair of primitives, that intersection is included in the learned definition. An arc can intersect a line, or another arc, in two locations. The occurrence frequency threshold for two intersections may also be, for example, 70%. The threshold for the existence of parallelism between lines may be, for example, 50%.

The standard deviation threshold for continuous valued quantities may be, for example, 5. The maximum value for a relative length is 100, thus the standard deviation threshold would be 5% of the maximum value. Absolute length is measured in pixels and primitives can be a few hundred pixels long. Thus, the threshold for absolute length can be a little more restrictive than for relative length if large symbols are drawn. The maximum value for an intersection angle is 180 degrees. The standard deviation threshold, therefore, is about 2.8% of the largest possible intersection angle.

During training, it is assumed that the all of the examples have the same number and types of primitives. Furthermore, it is assumed that the primitives are drawn in the same order and in the same relative orientation. For example, if the four sides of a square are drawn in a clockwise loop with the end of one side connecting to the start of the next, then all examples should be drawn that way. Drawing the square by first drawing one set of parallel sides and then drawing the other set, would constitute a different drawing order. Having the end of one side connect to the end of another (rather than the start) would constitute a different relative orientation. These assumptions make it trivial to determine which primitives in one example match those of another. The advantage is that training costs are negligible.

Symbol Recognition: Matching (Construction of a Description of the Unknown Symbol and Matching the Description to Known Definitions)

After drawing a symbol, the drawer indicates that the symbol is finished by using the stylus to press a button displayed on the drawing surface (e.g., CRT or whiteboard). This begins the process of recognizing the symbol, i.e., finding the learned definition that best matches the description of the unknown symbol. After a description of the unknown symbol is constructed using the techniques described above, we may employ one of two methods for performing the recognition (matching) task. The first employs the same assumptions used during training. The symbol must have the correct number of primitives, drawn in the correct order, and with the correct relative orientation. This method is computationally inexpensive, and is therefore quite fast. The second method uses a heuristic search technique to relax many of these assumptions, although other types of search techniques (e.g. brute force) may be used. This allows for much more variation in the way a symbol is drawn, but is correspondingly more expensive. We discuss first the non-search method, as the other method is an extension of it.

For the non-search method, the order in which one draws the primitives directly indicates correspondence with the primitives in a definition. The error in the match can be directly computed by comparing the semantic networks of the unknown and the definition. This is accomplished by comparing each of the attributes and relationships included in the definition to those of the unknown. The definition that matches with the least error classifies the example. However, a maximum error can be set, such that if the best fit exceeds that maximum, the symbol is not classified (recognized).

Matching errors occur when the number and types of primitives in the unknown symbol, their properties, and their relationships differ from those of the definition. When evaluating the total error, different weights are assigned to different kinds of errors. These weights reflect our experience with which characteristics of a symbol are most important for accurately identifying a symbol.

Some of the errors are quantized, that is an error is assigned based on the number of differences, as described in Table 1. An error is assigned if the unknown symbol and definition have different numbers of primitives. The weight for this may be 0.15, that is the error is 0.15 times the absolute value of the difference. For example, if the unknown has 5 primitives, and the definition has 7, the error is 0.3. Similarly, an error is assigned if the type of a primitive in the unknown is different than that of the definition. The weight for this error may be 1.0. Likewise an error of 1.0 may be assigned for each missing intersection or parallelism between primitives.

TABLE 1
Weights assigned to quantized errors.

| Quantity | Weight |
|---|---|
| Primitive count | 0.15 |
| Primitive type | 1.0 |
| Intersection | 1.0 |
| Parallelism | 1.0 |

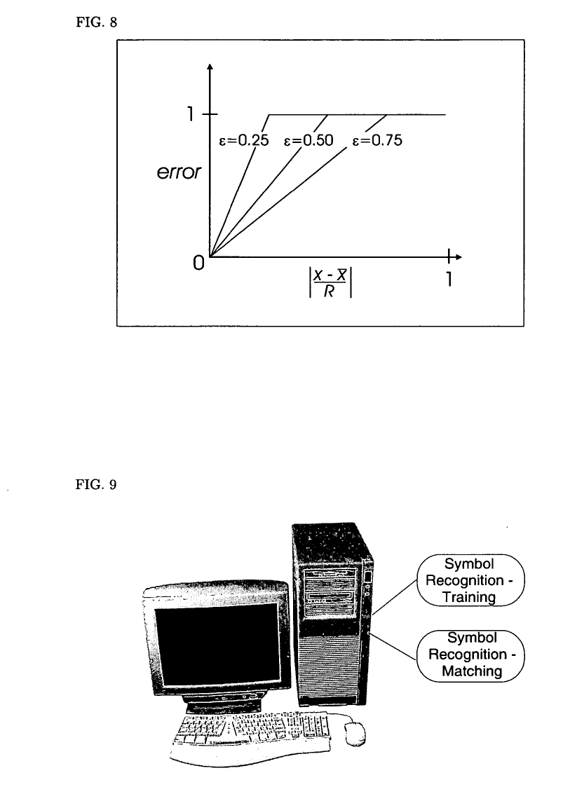

The remaining errors are assigned based on the size of the differences, rather than on the number of differences. These proportional errors are used for real valued properties such as relative length or intersection angle. Our error function is a saturating linear function:

$$e ( x ) = min \{ \begin{matrix}\vert \frac{x - \overline{x}}{ɛ R} \vert \\ 1.0\end{matrix} \} \qquad ( 1 )$$

where x is the observed value of a property, \overline{x} is the mean value of the property observed in the training examples, ∈ is a tolerance, and R is the maximum expected value for the property. The error saturates at 1.0. ∈ determines how quickly the error saturates as shown in FIG. 8. The smaller the value of ∈, the faster the function saturates. ∈ can be thought of as an error tolerance, because its value determines how much deviation in the property is allowed before the maximum error is assigned. Table 2 shows example values of the error constants used for the various continuous valued properties.

TABLE 2
Constants used for calculating the error for continuous valued properties.

| Property | Range, R | Tolerance, ∈ |
|---|---|---|
| Absolute length | Ave. from training | 1.0 |
| Relative length | 100.0 | 1.0 |
| Intersection location | 100.0 | 0.33 |
| Intersection angle | 180.0 | 0.17 |

The more primitives and properties contained in a definition, the more opportunities there are to accumulate error. It may be possible for a definition with many primitives and properties to produce a larger error than a less comprehensive definition, even if the symbol in question is a better match for the former. To avoid this, we normalize the error with the following formula:

$${E}^{′} = min \{ \begin{matrix}\frac{E}{{n}_{prim} + {n}_{prop} + {n}_{rel}} + C \\ 1.0\end{matrix} \} \qquad ( 2 )$$

where E′ is the normalized error, E is the sum of all errors except the primitive count error, C is the primitive count error, nₚᵣᵢₘ is the number of primitives in the definition, nₚᵣₒₚ is the number of properties in the definition, and nᵣₑₗ is the number of relationships such as intersections. With this formula, the primitive count error is weighted much more heavily than the other kinds of errors. This expresses the notion that if the number of primitives in a symbol is significantly different from that of the definition, a match is unlikely.

We often find it useful to consider the accuracy of the match rather than the error. The accuracy is the complement of the error:
A=100.0(1.0−E′) (3)
An accuracy of 100 is a perfect match, while an accuracy of 0 is an extremely poor match. The unknown symbol is classified by the definition that matches with the highest accuracy. However, if that accuracy is less than about 65 or 70, the match is questionable.

Thus far, the discussion has concerned matching under the assumptions that the primitives are always drawn in the same order and in the same orientation. Now we consider a method for relaxing these assumptions to allow more variation in the way symbols are drawn. With our previous assumptions, we could rely on the drawing order to directly indicate correspondence between the primitives in the symbol and those in the definition. With our previous assumptions, the direction of the pen stroke directly indicated the relative orientation of a primitive. Here we use search to identify the correspondence between primitives and the relative orientations that best match the definition. Recall that relative orientation describes which end of a primitive is the start and which is the end.

Our search technique can be described as best-first search with a speculative quality metric and pruning. A search node contains a partial assignment of the primitives in the unknown symbol to those of the definition. A search node is expanded by assigning an unassigned primitive in the symbol to one in the definition. A search node is terminal if an assignment has been made for each of the primitives in the definition or if there are no remaining unassigned primitives in the unknown symbol.

The search process considers all known definitions at the same time. (It is possible to reduce computation by eliminating definitions that have significantly different properties than the unknown, such as definitions that have a significantly different number of primitives than the unknown.) The process is initialized by generating all possible assignments for the first primitive in each definition. When making the assignments, both choices of orientation are considered. As a consequence, if there are n definitions and m primitives, the search queue will initially contain 2*n*m nodes. It is possible to reduce the search space by postponing consideration of the relative orientation, but our implementation handles drawing order and relative orientation in a uniform way.

Our quality metric is the converse of the matching error. The search queue is sorted in decreasing order of the normalized matching error. The error is computed with Equation 2 except that the primitive count error is excluded. It is excluded because it would penalize most those nodes that are at the shallowest depth in the search tree. If the term were included, the search would become more like depth first search, because the nodes that had the largest number of assignments would have the lowest error, and thus would be expanded first.

For non-terminal nodes, the error in some of the properties cannot be evaluated because the associated primitives have not yet been assigned. For example, if one (or both) of a pair of intersecting lines has not been assigned, it is not possible to determine if the intersection actually exists or what the error in the location of the intersection would be if it did. In such cases, we use a speculative error estimate. If an error cannot be measured because some of the primitives have not been assigned, we assign a small default error. Currently, we assign a value of 0.05 for each such incomputable error, although other values may be used. Doing this makes sense because sketches, due to their imprecise nature, always differ to some extent from the learned definitions.

Our speculative error calculation helps to prevent poor partial assignments from being expanded further. If the initial few assignments produce a large error, and there are many properties that cannot yet be evaluated, the search node will be assigned a relatively large error value. When the queue is sorted, such nodes will effectively be eliminated from consideration. In this sense, the speculative error calculation helps the search to be efficient.

To limit the search, we set a maximum error threshold. If the error of any (non-terminal) node exceeds the threshold, it is pruned from the search. This, again, helps to make the search efficient. We typically use an error threshold of 0.2 to 0.3, although others may be used. Adjusting the threshold and the speculative error constant allow one to tune the search method. For example, by increasing the speculative error constant and decreasing the threshold, the search can be accelerated but there is an increased chance that the correct definition will not be found. Conversely, if the speculative error constant is set to zero and the threshold is made large, the search will become exhaustive, ensuring that the correct definition will always be found.

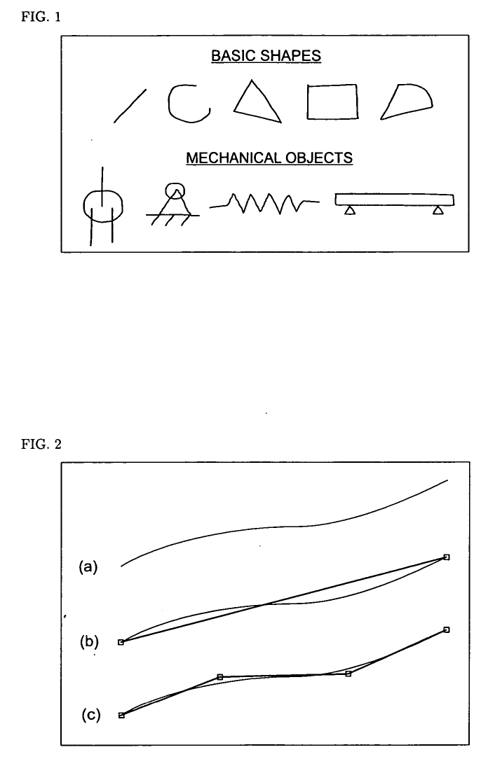

In informal tests, we have found that if the segmentation is accurate, the recognition rate is high. Our current system provides the user with the option to redraw incorrectly segmented strokes. When segmenting errors are corrected in this fashion, we achieve recognition rates of roughly 95% or better for symbols like those in FIG. 1.

We have found that often three or four training examples are adequate. Furthermore, our definitions have the ability to discriminate between similar shapes. For example, the system can distinguish between squares and non-square rectangles. Similarly it can distinguish between three lines forming a triangle and three lines forming a “U” shape.

Our search-based matching method has demonstrated that it is possible to accurately match symbols when the drawing order is varied. However, the method is expensive if there is a large number of definitions or a large number of primitives in the unknown symbol. There are simple things that can be done to make the approach more efficient. For example, the relative orientation property can be handled as a post-processing step. A default orientation can be assumed. If that results in appreciable errors in intersection locations, the orientation can be flipped.

The present invention is intended to be practiced on a computer, for example, the computer shown in FIG. 9. In the preferred embodiment, our disclosed methods of symbol recognition for both training and recognition are embodied in software and stored on the hard drive or any other type of storage device, either local or remote. The software is executed by the computer of FIG. 9 to enable the disclosed methods to be practiced.

The following discussion is an extension of the previously described techniques for segmenting pen strokes into lines and arcs. This approach also uses pen speed and curvature information to identify intended corners in a hand-drawn pen stroke. This approach includes a new way of computing curvature that naturally filters noise. The approach also includes new techniques to merge and split the initial segmentation to improve the overall accuracy of the segmentation.

Segmentation is the process of decomposing a pen stroke into the constituent geometric primitives. For the domains of interest to us, the primitives consist of lines and arcs. Our segmentation technique relies extensively on pen speed information for identifying the locations of intended segment points. Our approach also considers the final shape of the ink, by using curvature information to find other segment points. To achieve high accuracy, our approach monitors its own performance and improves the segmentation when necessary.

To begin the segmentation process, an initial set of candidate segment points are identified. This set includes the points on the pen stroke at which speed is a minimum or curvature is a maximum. (The complete criteria for selecting segment points is described below.) The ink between each pair of consecutive segment points is referred to as a segment. Each such segment is classified as line or arc, depending upon which best fits the ink.

Although the initial segmentation is usually reasonably accurate, feedback can be used to improve the accuracy. If the initial segmentation does not accurately match the original ink, segments are either merged or split to improve the fit. For example, if two adjacent segments form pieces of the same arc, it is likely that they were intended to be part of the same arc. In this case, the two are merged into a single arc segment. Conversely, if a particular line or arc is a poor fit for the ink, additional segment points are considered. This situation often occurs when there is a smooth change in the sign of curvature, for example, when moving from one lobe of an “S” shape to the other as shown in FIG. 14. This kind of transition can be made without slowing the pen, and thus is not detected as a speed minima. Consequently, if a segment is a poor fit for the ink, points at which the curvature changes sign are considered as additional candidate segment points. Such points are not considered initially because a change in the sign of curvature is not a reliable indication of an intended segment point. For example, in regions in which a pen stroke is nearly straight, it is typical for the sign of the curvature to fluctuate due to minor fluctuations in the ink.

The sections that follow describe the various steps of the segmentation process including: initial processing of the ink, identification of segment points, fitting of segments, and merging and splitting.

Initial Processing of the Ink

Our software is designed work with a digitizing tablet and stylus, or other similar device, that provides time-stamped coordinates. For example, we have used Wacom Cintiq and Intous II tablets, and a Tablet PC. During the initial processing phase, we use the time-stamped coordinates to compute pen speed and curvature. The first step is to construct the arc length coordinate of each point. Arc length is measured along the path of the pen stroke, and is computed by summing straight line distances:

$${d}_{i} = {\sum }_{j = 1}^{i} \vert {{P}^{->}}_{j} - {{P}^{->}}_{j - 1} \vert \qquad ( 4 )$$

where \vec{P}ⱼ is the coordinates of the j^{th} data point. The first data point has index j=0 and d₀=0.

We then use a centered, finite difference approach to compute pen speed:

$${s}_{i} = \frac{{d}_{i + 1} - {d}_{i - 1}}{{t}_{i + 1} - {t}_{i - 1}} \qquad ( 5 )$$

where tᵢ is the time-stamp of the i^{th} point. The speed at the first and last point of a pen stroke are taken to be equal to the speed at the second and penultimate points, respectively. Often, there is noise in the pen speed signal. To correct this, we apply a simple smoothing filter. The speed at each point is averaged with that of the two points on either side. After averaging, the first two and last two points in the pen stroke are assigned speeds equal to those of the third and third to last points, respectively. Other smoothing filters may be used.

There are various ways of computing curvature. For example, one could use the standard formula from analytic geometry (Michael E. Mortenson. Geometric modeling. John Wiley & Sons, Inc., 1985):

$$C = \frac{\dot{x} \ddot{y} - \ddot{x} \dot{y}}{{[ {\dot{x}}^{2} + {\dot{y}}^{2} ]}^{3 / 2}} \qquad ( 6 )$$

where the dot indicates differentiation with respect to the arc length, s. For digital data, the derivatives are typically evaluated using a finite difference technique. For the purposes of identifying segment points, however, the resulting curvature data would require a significant amount of smoothing, for example, by means of a Gaussian filter.

As an alternative approach, we compute curvature as the derivative of the tangent angle, θ, with respect to arc length:

$$C = \frac{\partial θ}{\partial s} \qquad ( 7 )$$

We use this approach for several reasons. First, our system already computes an accurate tangent, which is used for other purposes. Second, this method naturally smoothes the data so that no additional smoothing is needed.

To construct the tangent at a given point, we first construct a least squares line fit to a window of data points centered around that point. Using a window of points has the effect of smoothing noise. Some of the noise comes from minor fluctuations in the drawing, while other noise comes from the digitizing error of the input device. The larger the window, the larger the smoothing effect. We have found that a window of eleven points (five on other side of the point in question) provides adequate smoothing without loss of essential information about the shape, although other numbers of points may be used.

If the least squares line fit is an accurate fit for the window of points, the line is used as an approximation of the tangent. Accuracy is defined as the average distance from the points to the line. If this is less than, for example, 10% of the arc length of the window of points, the line it is deemed acceptable. Otherwise, a least squares circle fit is constructed, and the tangent is taken from the circle. In either case, the tangent direction is selected so as to align with the local direction of the pen motion.

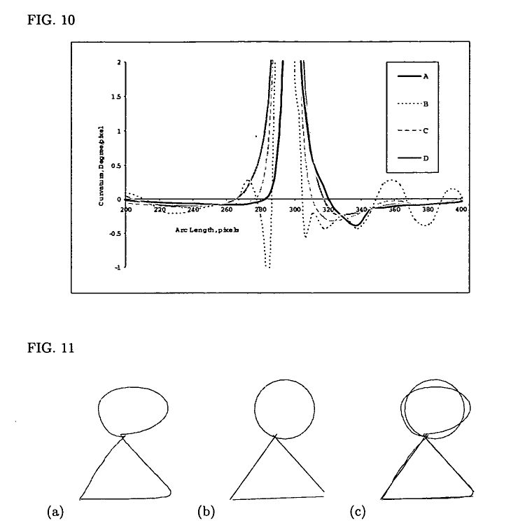

To compute the rate of change of the tangent angle, we could numerically differentiate the tangent angle data, but this would again require smoothing. Thus, we again use a least squares line fit. In this case, we consider the graph of the tangent angle versus the arc length. Care is taken to avoid false discontinuities in the tangent angle: For each point, we adjust the angle by adding or subtracting multiples of 2π until it differs in absolute value by less than 2π from the angle of the previous point. The slope of the least squares line gives the rate of change of curvature in units of radians per pixel. Here again, when computing the least squares line, we use a window of eleven points as a means of smoothing the data. FIG. 10 shows curvature data computed with our technique and the traditional approach from Equation 6. Comparison of traces A and B shows that our approach produces significantly smoother curvature data. To estimate the amount of smoothing our approach achieves, we repeatedly applied a Gaussian filter to the data from Equation 6 (trace B) until the smoothing was comparable to that of our data (trace A). In each application of the filter, the new value at a data point was taken to be 0.5477 times the current value plus 0.2236 times the sum of the current values on either side. We found that between roughly 5 (trace C) and 10 (trace D) applications of the filter resulted in an equivalent amount of smoothing.

We have found that our approach to calculating curvature works well in practice. In fact, this approach is similar in spirit to the way draftspersons used to compute graphical derivatives in the era before computers. In some sense, we are smoothing the way a draftsperson would by eye. As FIG. 10 shows, however, our approach is comparable to the traditional calculation (Equation 6) combined with Gaussian smoothing. Thus, if desired, one could directly implement our segmentation approach using the more traditional technique.

Least Squares Line and Arc Fitting

Least squares line and arc fitting is used for multiple purposes in our system. As described above, it is used for computing both tangents and curvature. It is also used for fitting lines and arcs to the segmented ink. For completeness, this section provides a review of the least squares techniques we use.

For sake of efficiency and simplicity, we use a linear least squares fit. The line is defined as:
y=Ax+B (8)
Minimizing

$${\sum }_{i = 1}^{n} {( {Ax}_{i} + B - {y}_{i} )}^{2}$$

results in the regression equation:

$$[ \begin{matrix}n & \sum {x}_{i} \\ \sum {x}_{i} & \sum {x}_{i}^{2}\end{matrix} ] [ \begin{matrix}A \\ B\end{matrix} ] = [ \begin{matrix}\sum {y}_{i} \\ \sum {x}_{i} {y}_{i}\end{matrix} ] \qquad ( 9 )$$

where n is the number of data points and the (xᵢ, yᵢ) are the coordinates of a data point. The linear least squares technique fails if the line is nearly vertical, because error is defined as the vertical distance from a data point to the line. To avoid this, if the data points have little variation in the x direction, we instead fit the data to the line x=Ay+B. We could have used a non-linear least squares fit in which the error is defined as the minimum (perpendicular) distance from a data point to the line. Such an approach would be more accurate and would not require special treatment of vertical lines, but it would be more expensive computationally.

For fitting circles, we again use a linear least squares approach. The circle is defined as:
x²+y²+2ax+2by+c=0 (10)
where (−a, −b) is the center of the circle, and the radius is r=\sqrt{a²+b²−c}. Minimizing the total squared error

$${\sum }_{i = 1}^{n} {( {x}_{i}^{2} + {y}_{i}^{2} + 2 {ax}_{i} + 2 {by}_{i} + c )}^{2}$$

results in the regression equation:

$$[ \begin{matrix}2 \sum {x}_{i}^{2} & 2 \sum {x}_{i} {y}_{i} & \sum {x}_{i} \\ 2 \sum {x}_{i} {y}_{i} & 2 \sum {y}_{i}^{2} & \sum {y}_{i} \\ 2 \sum {x}_{i} & 2 \sum {y}_{i} & n\end{matrix} ] [ \begin{matrix}a \\ b \\ c\end{matrix} ] = [ \begin{matrix}\sum - ( {x}_{i}^{2} + {y}_{i}^{2} ) {x}_{i} \\ \sum - ( {x}_{i}^{2} + {y}_{i}^{2} ) {y}_{i} \\ \sum - ( {x}_{i}^{2} + {y}_{i}^{2} )\end{matrix} ] \qquad ( 11 )$$

This technique works well for moderately curved ink. If the ink is nearly straight, the matrix becomes ill conditioned. To avoid this, we first consider a line fit before considering a circle fit. There are more sophisticated least squares circle fitting techniques, but those techniques are computationally more expensive.

When evaluating the quality of fit, we use an average error. For non-vertical lines (those described by Equation 8), the error of fit is:

$$e = \frac{1}{n} {\sum }_{i = 1}^{n} \vert {Ax}_{i} + B - {y}_{i} \vert \qquad ( 12 )$$

For vertical lines, or those that are nearly so, the absolute value term becomes: Ayᵢ+B−xᵢ. For circles, the error of fit is:

$$e = \frac{1}{n} {\sum }_{i = 1}^{n} \vert \sqrt{{( {x}_{i} + a )}^{2} + {( {y}_{i} + b )}^{2} )} - r \vert \qquad ( 13 )$$

Candidate Segment Points

Once the initial processing of the ink is completed, the next step is to compute the set of initial candidate segment points. The first and last points on a pen stroke are always included in the initial set. The remaining segment points are identified by examining speed and curvature data.

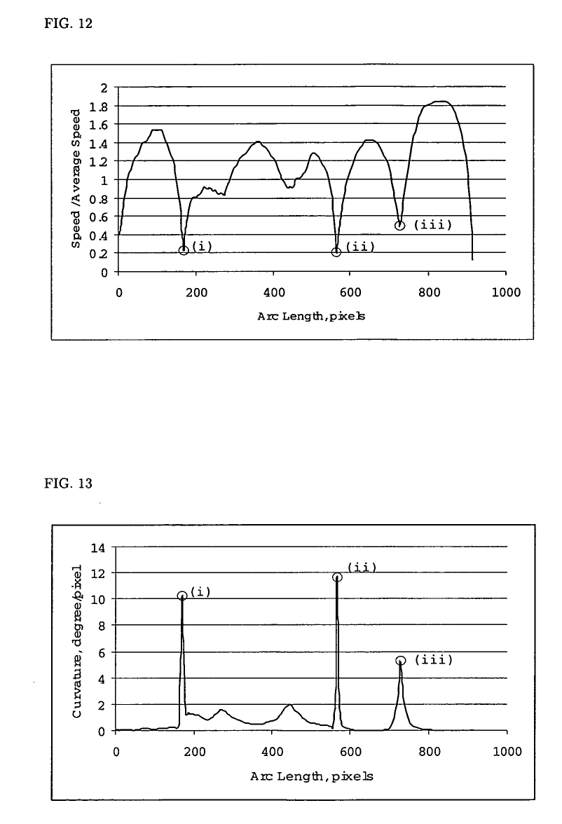

Our most reliable criterion for selecting segment points is based on pen speed. Segment points occur at locations at which pen speed is a local minimum. Consider, for example, the sketch of a pivot in FIG. 11(a). This sketch, which was drawn with a single pen stroke, was intended to be three lines and an arc (FIG. 11(b)). FIG. 12 shows the speed profile for the pen stroke. The intended segment points correspond to local speed minima as indicated by circles. There are, however, other speed minima that do not correspond to intended segment points. The latter are distinguishable by their higher speed.

Our approach, therefore, is to locate segment points at speed minima that are slower than some threshold. We select, for example, the threshold as a fraction of the average speed along the pen strokes. (The ordinate in FIG. 12 directly corresponds to possible values of the threshold.) In practice, a threshold of between 25% and 100% of the average speed works well. A larger threshold may decrease the number of intended segment points that are missed, while smaller values may decrease the number of unintended segment points that are selected.

Interestingly, we have found that our approach is not very sensitive to the particular value of the threshold used. For example, our user studies discussed below show little variation in the overall accuracy of the segmentation over the range in threshold from 25% and 100%.

We typically use a small threshold (25%) because very low pen speed is a clear indication of an intended segment point. If a speed minima is above the threshold, the point may still be a segment point, but additional information is required to be certain. In this case, we examine the curvature of the ink. In FIG. 12, for example, segment points (i) and (ii) are detected with a threshold of 25%. Segment point (iii) is above this threshold, but, as shown in FIG. 13 this point corresponds to a maximum of curvature, which provides additional evidence about the existence of a segment point.

One approach to identifying segment points would be to identify points that are both a minima of speed and maxima of curvature. In practice, we have found it adequate to simply identify points that are a maxima of curvature and which have low speed. This avoids problems when speed minima and curvature maxima are nearby, but not precisely coincident.

Based on empirical studies, we have identified a reliable criterion based on both curvature and pen speed: If a point is an extrema of curvature (rate of change of tangent angle), the magnitude of the curvature exceeds, for example, 0.75 degree/pixel, and the pen speed is less than, for example, 80% of the average pen speed, the point is included in the initial list of candidate segment points. The second requirement helps with nearly straight lines. Often the sign of the curvature fluctuates for such lines, resulting in multiple extrema. However, because the ink is nearly straight, the magnitude (absolute value) of curvature at the extrema is quite small. The thresholds used here work well for the Wacom digitizing tablets we use, and have proven to work well for a wide range of users, but will likely need tuning for other hardware.

The speed-based and curvature-based segment points are always included in the initial set of segment points. There is a third class of segment points that are not considered initially. These are the points at which the curvature changes sign. We define three qualitative “signs” for curvature: +1 if the magnitude is greater than 0.1 degree/pixel, −1 if the magnitude is less than −0.1 degree/pixel, and 0 otherwise. Other thresholds can be used. These thresholds were determined empirically to eliminate irrelevant fluctuations in the curvature that occur for nearly straight lines. Again, these values work well for our hardware, but will likely require tuning for other hardware.

A change in curvature sign is not a reliable indication of an intended segment point. As a result, such points are typically considered only when the other segment points do not result in a good fit for the ink. For example, it is common for there to be a change in curvature sign on each side of a 90 degree corner as shown in FIG. 15. It is clear that such changes in curvature sign do not correspond to intended segment points.

For this reason, segment points based on curvature sign are not part of the set of initial candidate segment points. Instead, they are considered during the splitting process described below. In essence, a change in the sign of curvature is not adequate evidence to decide that a segment point was intended. Instead, additional information about the gross shape of the ink is needed. This information comes from examining how well the initial segmentation fits the ink.

Due to noise, it is possible for there be to be small clusters of closely located segment points. For example, there may be two speed minima that are separated by only one a few data points, or there may be a speed minima near a curvature maxima. Thus, once the speed and curvature segment points are calculated, the data is filtered to eliminate nearly coincident segment points. If a segment point is within seven data points of a subsequent segment point, it is eliminated, although other numbers of data points may be used.

Fitting Segments

Once the initial set of candidate segment points have been identified, the next step is to fit primitives to the segments. Least squares line and circle fits are constructed for the segment between each pair of adjacent segment points. The segment is typically classified by whichever shape fits it with the smallest error of fit as discussed above. In practice, it is common for nearly straight lines to be accurately fit by an arc with a large radius. In fact, even a straight line can be perfectly fit by an arc with infinite radius. Thus, even if a segment is best fit by an arc, it is classified as such only if it would represent at least one tenth of a circle (36°), although other thresholds can be used.

If a segment is classified as a line segment, the end points of that line segment are determined by constructing perpendiculars from the first and last data points to the least squares line. Similarly, for arcs, the end points are determined by a constructing radial lines through the first and last data points. This approach may result in gaps between segments where no gaps existed in the original ink. For the purposes of recognition, however, this does not pose a problem because tolerances are used when evaluating the topology. For beautification, however, it would be necessary to adjust the end points so as to preserve the original connectivity of the segments.

Merging and Splitting

Once the initial segments have been computed, a quality control process may be begun. The segments are compared to the original ink, and segments are merged, split, and deleted as necessary. In this fashion, feedback is used to improve the accuracy of the segmentation. If there is a very short segment adjacent to a long one, we have found that, frequently, the short one was unintended. Thus, if a segment is shorter than 20% of the length of an adjacent segment, the program attempts to merge them. (This constant, as well as all of the others constants and thresholds used for merging and splitting, were obtained empirically. Other values for these constants and thresholds may be used.) The program computes a new segment containing all of the data points of the two original segments. The type of this new segment is forced to be the same as that of the longer of the original two. For example, if a short line segment is adjacent to a long arc, the program attempts to join them into a single arc segment. If the error of fit (as discussed above) of the new segment is no more than, for example, 10% greater than the sum of the fit errors of the original two segments, they are discarded and replaced with the new one. Otherwise, the new segment is discarded.

A special case of this procedure is applied to the two ends of each pen stroke. We have found that at the start and end of a pen stroke, the stylus often leaves small, unintended bits of ink that form sharp discontinuities. We believe that this is due to deflection of the elastic stylus tip. As the stylus is pressed against the digitizing tablet, the tip compresses, and when the stylus is lifted, the tip relaxes. We have found it useful, therefore, to eliminate small segments at the start of pen strokes. A segment is discarded if it contains fewer than 15 data points, although other numbers of data points can be used. Similarly, if the first or last segment is much shorter than its immediate neighbors, it is discarded. For example, if the first segment is shorter than 10% of the average length of the first three segments, it is discarded.

If adjacent segments are of the same type, the program checks to see if they might reasonably be interpreted as the same segment. For example, if two arcs are adjacent, the program computes a new arc containing the data points from the two original arcs. If the error of fit is no more than, for example, 10% greater than the sum of the original errors of fit, the two arcs are replaced by the new one. Note that the program considers merging two segments only if their drawing directions are consistent. For arcs, the requirement is that they both be drawn in the same sense, i.e., both clockwise or both counterclockwise. Similarly, for line segments, the program constructs unit vectors from the lines, and attempts a merge only if the dot product of these vectors is greater than 0.75, although other tolerances can be used.

If a particular least square line or arc does not fit the ink well, the program attempts to improve the fit by including a segment point based on a change in the sign of the curvature. The program splits a segment in this fashion if the fit error is greater than seven pixels, although other numbers of pixels could be used. In other words, if, on average, the data points are at least seven pixels from the least squares line or arc, the program attempts to split the segment. This value was determined empirically to work with our hardware when set at resolutions of 1024×768 and 2048×1536. The value does work well for most users, but it would likely require tuning for use with different sketching hardware.

Typically there are only a few curvature-sign segment points in any given segment. Thus, it is feasible to exhaustively consider each of them. The program considers splitting the segment with each of the curvature-sign segments points, one at time. The best choice is the one in which the sum of the fit errors for the two new segments is minimum. If this minimum is less than 65% of the original fit error, the new segmentation is retained, otherwise it is rejected. Other thresholds can be used. This threshold is designed to require significant improvement in the fit before a new segment point is added.

FIG. 14 shows an example of how curvature-sign points are used. In the initial segmentation, curvature sign points are excluded, and the stroke is segmented into a single arc segment. Because the fit is poor, the program tests both curvature-sign points in the middle of the curve and finds that an improved segmentation can be achieved. The result is shown in FIG. 14b.

FIG. 15 shows why curvature-sign points are not considered unless the initial segmentation is poor. Fluctuations in approximately straight portions of the pen stroke result in a large number of curvature sign changes. These are clearly unintended segment points.

We have also developed a more advanced splitting technique that uses dynamic thresholds. Rather than using a fixed threshold of seven pixels, the program uses a variable threshold to determine when splitting is necessary. The threshold is based on the length of the segment, such that shorter segments have a smaller threshold than larger ones. The maximum allowable error of fit before splitting is attempted is the minimum of 1.0+S/50.0 and 8.0, where S is the arc length of the segment. (Other threshold functions can be used.) If splitting is necessary and no curvature-sign points are useful for improving the error of fit, the program attempts to improve the fit by looking for additional speed-based segments points. Candidate segment points are enumerated by setting the speed threshold to 130% of the average speed, although other thresholds can be used. (The new candidates are minima of speed less that 130% of the average.) Then, just as before, if the best candidate results in an error of fit that is less than, for example, 65% of the original error of fit, that candidate is added to the segmentation. The advanced splitting method is used in the AC-SPARC user study discussed below.

We have found it useful to apply the merging and splitting routines repeatedly. For example, we typically apply the routines as follows: The special merging routine that handles noise at the start and end of each stroke is applied first. Next, the general routines for merging segments are applied, followed by two applications of the splitting routine. It is possible that splitting may produce segments that should be merged with their neighbors. Thus, the final step consists of an additional application of the general merging routines. More or fewer applications of these techniques can be used.

System

We have deployed our segmenter using a Wacom Intous II 9 in×12 in tablet, a Wacom Cintiq 15× LCD tablet, and a tablet PC. With the later two, the user draws directly on the display, and virtual ink is rendered directly under the stylus tip. With the Intous II, the user draws on the tablet, and virtual ink is rendered on the display. As a means of providing better feedback to the user, the Intous II can also be used with an “inking” stylus. In this case, paper is placed over the tablet and the stylus tip leaves physical ink. Our system provides the option of displaying virtual ink in its raw or segment form. In the latter case, the current pen stroke remains in its raw form until the stylus is lifted, and then the segmented ink is displayed.

One of the difficulties in using a conventional tablet and stylus, such as the Intous II, is that the stylus and ink are in different locations. As one partial remedy, our system provides a mode in which a 3D image of the stylus is rendered on the display along with the virtual ink. This mode works with the Intous II, which provides time stamped data packets that include the coordinates of the stylus, the tip pressure, and two stylus angles. These angles are adequate for uniquely locating the orientation of the stylus. (The stylus is axisymmetric, thus a third angle is unnecessary.) As the user draws, our software renders the stylus at the same orientation as the physical stylus. It also uses color coding to indicate the tip pressure.

We have found that when a conventional stylus is used, users tend to draw moderately sized shapes. In that case, we have found that setting the resolution of the digitizing tablet to 1024×768 is adequate. When an inking stylus is used, users sometimes draw smaller shapes, and thus it is necessary to increase the resolution of the tablet. We have found that doubling the resolution to 2048×1536 is sufficient. We have also found it useful to exclude tip pressure and stylus angles from the data packets to increase the data transfer rate when the high resolution mode is used. For the low resolution mode, we have found a speed threshold of 25% of the average speed to be suitable for most users. For the high resolution mode, we typically use a much higher threshold of 85% of the average speed.

We performed nearly all of the system development using the low resolution mode and the conventional stylus. When developing the high resolution mode, the only threshold we modified was the speed threshold. It is likely that better high-resolution performance can be achieved by optimizing the thresholds associated with curvature.

When a conventional stylus is employed, our software allows the user to add and remove segment points, and erase strokes and segments. Segment points are added by pressing a button on the side of the stylus and drawing a line across the ink at the desired location of the new segment point. Similarly, with the button pressed, drawing a circle around a set of segments will merge them together. To erase ink, the user simply turns the stylus over and uses the eraser in the usual fashion. A few strokes of the eraser will remove a segment; many strokes will remove an entire pen stroke.

User Studies

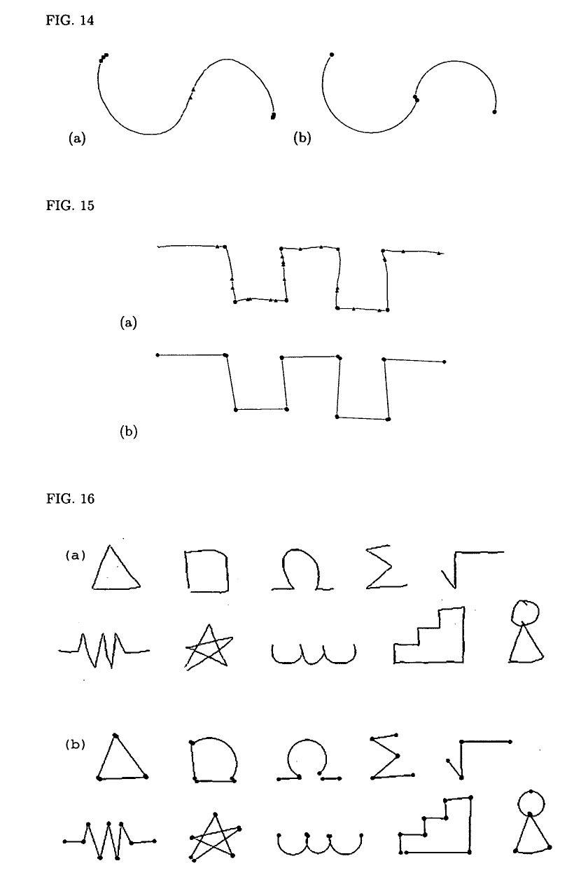

To test our segmenter, we conducted two user studies in which multiple users were asked to draw the set of shapes shown in FIG. 16a. The users were instructed to draw accurately but naturally, and were informed that the experiment was intended to evaluate the accuracy of our segmenter. We specifically selected users who had no previous experience with our system, but who did have at least some experience using a PDA or digitizing tablet. Users were given only a minute or two to become familiar with the system before providing samples for the study. Thus, our results reveal how well our software performs for the new user. We have found that after one has gained moderate experience with our system, one is able to achieve even higher accuracy than demonstrated in these studies.

The Intous II with inking stylus was used for both studies. Also, the display showed the raw ink rather than the segmented ink, as we did not want the user to alter his or her drawing based on the program's performance. In fact, the users were given no feedback at all about how well the program performed. Note that these studies employed our fixed threshold splitting method rather than the dynamic threshold method. It is likely that even better results would have been obtained if we had used the latter.

The first user study evaluates the suitability of our speed threshold for the typical user. For this study, the digitizing tablet was set to the low resolution mode. Five users were asked to draw the ten symbols in FIG. 16a four times each. All users were asked to draw the shapes at a size of approximately 3 cm, which is a comfortable size when viewing the ink on the computer display. (The second user study, described below, explores accuracy as a function of symbol size.)

TABLE 1
User study with default speed threshold, 25%.

| User | 1 | 2 | 3 | 4 | 5 | Average |
|---|---|---|---|---|---|---|
| Num Segment | 230 | 229 | 244 | 229 | 233 | 233 |
| Points | | | | | | |
| Missing Seg | 11 | 5 | 17 | 0 | 2 | 7.0 |
| Points | | | | | | |
| Mistakenly | 2 | 1 | 2 | 0 | 0 | 1.0 |
| Merged | | | | | | |
| Missing | 0 | 1 | 3 | 0 | 0 | 0.8 |
| Start/End | | | | | | |
| Extra Seg | 0 | 3 | 0 | 0 | 2 | 1.0 |
| Points | | | | | | |
| Seg Points | 94.3% | 95.6% | 91.0% | 100.0% | 98.3% | 95.8% |
| Correct | | | | | | |
| Correct | 82.5% | 82.5% | 67.5% | 100.0% | 90.0% | 84.5% |
| Symbols | | | | | | |

Table 1 shows the results of the first study. The performance of the system was evaluated in terms the number of missing and extra segment points. Missing points can occur for one of three reasons: (1) no candidate segment point was found, (2) a candidate was found but was later eliminated by merging of the two adjacent segments, or (3) a candidate was found but was later eliminated during the clean up of the start or end of the pen stroke. Extra points are those that were not intended as segment points, but were labeled as such by the program.

When evaluating the accuracy of the computed segmentation, it was first necessary to account for variations in the way each user drew the shapes. For example, the number of intended “wiggles” in the spring-like symbol varied from one user to the next. Table 1 tabulates the number of intended segment points for each user, which was typically about 230 for the complete set of 40 examples provided by each user. The set of intended segment points included the end points of each pen stroke. End points are explicitly considered because it is possible for them to be eliminated while attempting to clean up noise from the start or end of a stroke. The segmentation error for each user is defined as the sum of the missing and extra segment points divided by the total number of intended segment points. The segmentation accuracy is defined as one minus this value. The average segmentation accuracy across all five users was 95.8%.

Most of the segmentation errors occurred because no candidate segment point was identified. On average, there were 7 such errors for each set of 40 examples. Significantly fewer points were missed because of segment merging or start/end cleaning—there was approximately one of each of these errors for each set of 40 examples. We did notice, however, that some users drew the square root and summation symbols with very small serifs, which were incorrectly eliminated as start/end noise. (Some users drew large serifs, while other did not draw them.)

As shown on the last line of Table 1, on average, 84.5% of the symbols had no segmentation errors of any kind. On average, each symbol in the study contained about 6 segment points, thus there are multiple ways for there to be an error in a given symbol. This is why this measure of accuracy is lower than the first measure of segmentation accuracy described above.

FIG. 16a shows the actual ink drawn by one of the users (user 5). FIG. 16b shows the resulting segmentation. This is a typical result. There is only one segmentation error, which is the top right corner of the square. That corner was not drawn at low speed and does not have high curvature. The result was that the top and right sides of the square were segmented as a single arc segment. A segmentation approach that tried to minimize the difference between the raw ink and the segmented version might have computed two line segments, and possibly a small arc, in this case. However, such an approach would likely do a much worse job on many of the other shapes. For example, to get a precise match for the shape of the omega symbol would require multiple arc segments. However, our approach finds only one, the one that was intended.

In general, we have found that when the ink is correctly segmented at just the intended segment points, there can be a significant difference between the raw ink and the computed segments. This is, in fact, why our method directly looks for segment points, rather than attempting to find a good fit for the raw ink.

To evaluate how sensitive our approach is to the speed threshold, we resegmented the ink using a larger threshold. In Table 1, a threshold value of 25% of the average speed was used, but in Table 2, the threshold was increase to 100% of the average.

TABLE 2
User study with speed threshold of 100%.

| User | 1 | 2 | 3 | 4 | 5 | Average |
|---|---|---|---|---|---|---|
| Num Segment | 230 | 229 | 244 | 229 | 233 | 233 |
| Points | | | | | | |
| Missing Seg | 0 | 0 | 0 | 0 | 0 | 0.0 |
| Points | | | | | | |
| Mistakenly | 2 | 0 | 1 | 0 | 0 | 0.6 |
| Merged | | | | | | |
| Missing | 0 | 1 | 4 | 0 | 0 | 1.0 |
| Start/End | | | | | | |
| Extra Seg | 12 | 13 | 3 | 1 | 5 | 6.8 |
| Points | | | | | | |
| Seg Points | 93.9% | 93.9% | 96.7% | 99.6% | 97.9% | 96.4% |
| Correct | | | | | | |
| Correct | 72.5% | 75.0% | 87.5% | 97.5% | 90.0% | 84.5% |
| Symbols | | | | | | |

TABLE 3
Size study. Speed threshold 85%.

| | Symbol Size | | | |
|---|---|---|---|---|
| | 1 cm | 2 cm | 4 cm | 4 cm |
| Tablet Resolution | High | High | High | Low |
| Num Seg Points, Ave. | 58.0 | 57.8 | 58.4 | 57.0 |
| Missing Seg Points, Ave. | 2.0 | 0.2 | 0.0 | 0.4 |
| Mistakenly Merged, Ave. | 0.2 | 0.2 | 0.4 | 0.0 |
| Missing Start/End, Ave. | 1.2 | 0.4 | 0.2 | 1.0 |
| Extra Segment Points, Ave. | 1.0 | 2.0 | 2.0 | 1.0 |
| Seg Points Correct, Ave. | 92.4% | 95.1% | 95.6% | 95.8% |
| Correct Symbols, Ave. | 68.0% | 76.0% | 80.0% | 80.0% |

With the lower threshold, there was on average 8.8 missing segment points and 1 extra segment point for each set of 40 examples. With the higher threshold, there was on average 1.6 missing segment points and 6.8 extra ones. As one would expect, as the threshold increases, the number of missing points decreases and the number of extras increases.

For four of the users, accuracy decreased only a little with the increased threshold. This suggests that the accuracy of the approach is not overly sensitive to the threshold. For the third user, however, there was a significant increase in accuracy with the larger threshold. (This offsets the small decreases for the other four users, resulting in the same overall average accuracy.) Later discussions with that user revealed that he was a trained calligrapher and thus was skilled at maintaining a consistent pen speed so as to avoid ink blotches.

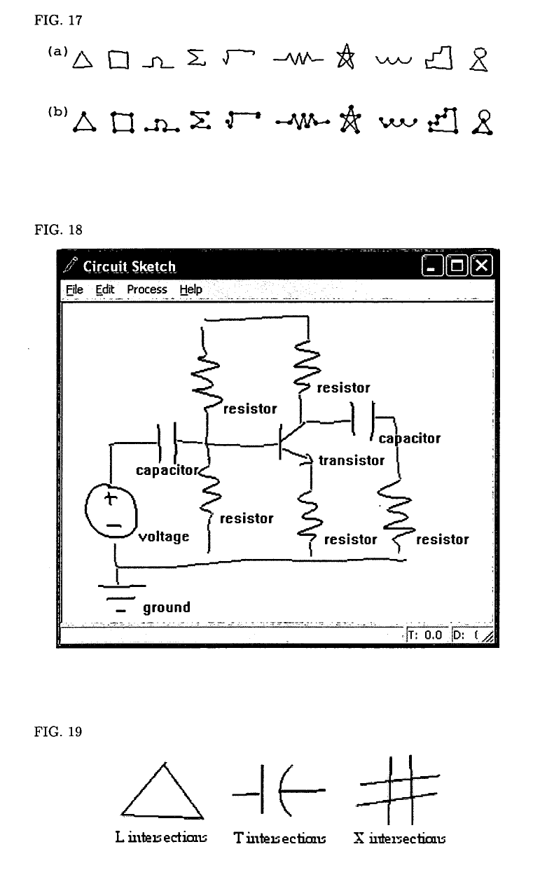

The second user study was intended to evaluate the accuracy of the system for various sizes of the ten shapes shown in FIG. 17. This study also employed five participants, one of which was user 1 from the first study. (The other four had not participated in the first study.) Using the high resolution mode, each user was asked to draw each of the ten symbols at sizes of 1 cm, 2 cm, and 4 cm. Then for comparison, each user drew the symbols at 4 cm using the low resolution settings used in the first user study. Overall, we found that the there was only a small decrease in accuracy for the smaller sized shapes. Similarly, on average, the accuracy for large symbols with the high resolution mode was the same as with the low resolution mode.

Sample Application: AC-SPARC

We have used our segmenter to build a sketch-based interface for the SPICE electric circuit analysis program. SPICE was developed in the Electrical Engineering and Computer Science Department at the University of California, Berkeley. Our interface is called AC-SPARC, for Analog Circuit Sketch PArsing, Recognition, and error Correction. Here we present a user study of AC-SPARC to demonstrate the performance of our segmenter in the context of a practical sketch-based application. First, however, we present a brief overview of the AC-SPARC system. A more detailed description of that system can be found in Leslie M. Gennari, Levent Burak Kara, and Thomas F. Stahovich, “combining geometry and domain knowledge to interpret hand-drawn diagrams,” AAAI 2004 Fall Symposium Series, Making Pen-Based Interaction Intelligent and Natural, 2004, which is hereby incorporated by reference in its entirety.

AC-SPARC allows users to operate SPICE by sketching schematics of analog circuits. FIG. 18 shows a typical circuit sketch drawn with the program. AC-SPARC is designed to provide a natural drawing environment by placing minimal constraints on the way the user sketches. The user can draw a symbol with any number of strokes, and each instance of a symbol can contain different numbers of strokes. Likewise, there are no requirements that the parts of a symbol be drawn in the same order in every instance. Furthermore, the user can draw multiple symbols in the same stroke, without lifting the pen. Having an effective segmenter is essential to achieving this kind freedom and flexibility in a drawing environment. The only constraint imposed by the system is that the user must finish drawing one symbol before starting the next. Thus, one cannot begin drawing one symbol, start on a second, and then return to the first. However, our observations during user studies indicate that people do not ordinarily draw diagrams in such an unfocused way.

AC-SPARC employs a novel parsing technique that automatically extracts symbols from a continuous stream of pen strokes, without requiring an explicit indication from the user about where symbols begin and end. (Traditional systems typically require the user to pause or press a button on the stylus between symbols.) The parser locates candidate symbols by looking for areas with a high concentration of pen strokes, or high “ink density” as it is called. Candidate symbols are also located by finding points in the temporal sequence of segments at which there are changes in the geometric characteristics of the segments. A point that separates a sequence of line segments from a sequence of arc segments would be an example. Once the candidates have been enumerated, domain knowledge is used to prune out unlikely symbols.

The candidates that survive pruning are recognized using a novel, domain-independent, probabilistic, feature-based recognizer. The features describe the number of geometric primitives (line and arc segments) comprising a symbol, and the geometric relationships between them. The features include the number of: pen strokes, line segments, arc segments, endpoint (“L”) intersections, endpoint-to-midpoint (‘T’) intersections, midpoint (“X”) intersections, pairs of parallel lines, and pairs of perpendicular lines. See FIG. 19. The final feature is the average distance between the endpoints of the segments. The statistical distributions of these features are described with a naive Bayesian framework, which naturally accounts for the kinds of variations typical of hand-drawn sketches. The recognizer is insensitive to drawing order, rotation, scaling, and the number of pen strokes used to draw a symbol.

Once the symbols have been recognized, domain knowledge and context are used to correct parsing and recognition errors. For example, if a symbol has been recognized as a capacitor, but has only one wire connected to it, the program checks with the recognizer to determine if a lesser ranked classification might be a better choice. For instance, if the next most likely classification is an electrical ground, the program would reclassify the symbol as such, because ground symbols have only one connection.

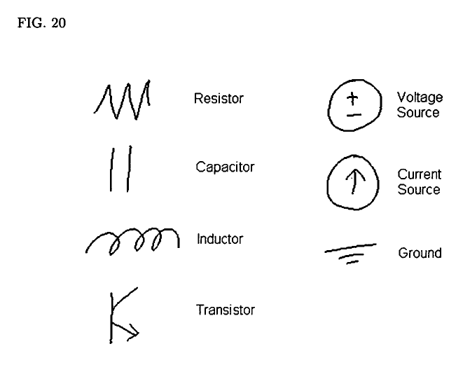

Ten users participated in the AC-SPARC user study. The subjects were all engineering students, and each had taken at least one class in the past that required them to draw and analyze electrical circuits. Only one subject had prior experience with a digitizing tablet, although several subjects had experience with pen-based computing through the use of PDA's. For hardware, we used the Cintiq LCD tablet and stylus with the high-resolution setting. The subjects sketched in the raw ink view, and thus did not see how their circuits were segmented. They were given no information about how the system works, and they were told only that they should finish drawing one symbol before drawing a wire or starting another symbol. To begin the test, the subjects were first asked to train the system by providing six examples of each of the symbols shown in FIG. 20. The subjects were then asked to draw a set of eight specific circuits. These contained between 6 and 16 symbols, with an average of 9.25 symbols per circuit.

The results of this study were quite promising: the segmenter correctly segmented 91% of the symbols. Accuracy was determined by examining the segmented ink to determine if it was a reasonable interpretation of what was drawn. In some cases, judgment was involved. The results obtained here are better than those of the previous section. This is likely due to the use of our dynamic threshold splitting technique. (There were a few other minor adjustment to the program, but their effects were minor.)

Recap

The challenge in segmenting a pen stroke is to identify the geometric primitives intended by the drawer. Frequently, the intent is not a literal interpretation of the stroke. In particular, the intended segmentation is often a poor fit for the raw ink. Consequently, a segmentation technique driven by the objective of matching the ink is likely to produce poor results. Rather, our approach uses pen speed information to help infer intent. We have observed that is common for the drawer to slow the pen tip at points of intended discontinuities in a pen stroke.

Based on this insight, we have developed a technique for segmenting hand-drawn pen strokes into lines and arcs. To begin the segmentation process, an initial set of candidate segment points is identified. This set includes speed minima below a threshold, where the threshold is computed from the average pen speed along the pen stroke. The set also includes curvature maxima at which the pen speed is again below a threshold. Once the initial set of candidates has been generated, the ink between each pair of consecutive segment points is classified as either a line or arc, depending on which fits best. A feedback process is then employed, and segments are merged and split as necessary to improve the quality of the segmentation.

Although the present invention has been described in conjunction with preferred embodiments thereof, those of ordinary skill in the art will recognize that many modifications and variations are possible. The present invention is not to be limited by the preceding description but only by the following claims.

1. A method of analyzing a symbol comprised of one or more drawn strokes, comprising:
calculating the speed of drawing along each stroke;
calculating a curvature magnitude along each stroke;
identifying an initial set of candidate points defining initial segments using said calculated speed and curvature magnitude;
classifying each initial segment as a type of primitive;
comparing said initial segments to said original stroke;
merging and splitting any of said initial segments in response to said comparing to produce new segments; and
reclassifying each of said new segments as a type of primitive.

2. The method of claim 1 wherein said calculating the speed of drawing is performed using a finite difference approach.

3. The method of claim 1 wherein said calculating the curvature magnitude includes computing the derivative of the tangent angle with respect to arc length.

4. The method of claim 1 wherein said classifying and reclassifying includes using a least squares best fit.

5. The method of claim 1 wherein said identifying an initial set of candidate points includes the first and last points of the stroke.

6. The method of claim 1 wherein said splitting of said initial segments includes splitting segments at points in response to a measure of curvature sign.

7. A method of analyzing a symbol comprised of one or more drawn strokes, comprising:
calculating the speed of drawing along each stroke;
calculating a curvature magnitude along each stroke as the derivative of the tangent angle with respect to arc length;
identifying an initial set of candidate points defining initial segments using said calculated speed and curvature magnitude; and
classifying each initial segment as a type of primitive.

8. The method of claim 7 additionally comprising:
comparing said initial segments to said original stroke;
merging and splitting any of said initial segments in response to said comparing to produce new segments; and
reclassifying each of said new segments as a type of primitive.

9. The method of claim 7 wherein said calculating the speed of drawing is performed using a finite difference approach.

10. The method of claim 8 wherein said classifying and reclassifying include using a least squares best fit.

11. The method of claim 7 wherein said identifying an initial set of candidate points includes the first and last points of the stroke.

12. The method of claim 8 wherein said splitting of said initial segments includes splitting segments at points in response to a measure of curvature sign.

13. A memory device carrying a set of instructions for performing a method of analyzing a symbol comprised of one or more drawn strokes, the method comprising:
calculating the speed of drawing along each stroke;
calculating a curvature magnitude along each stroke;
identifying an initial set of candidate points defining initial segments using said calculated speed and curvature magnitude;
classifying each initial segment as a type of primitive;
comparing said initial segments to said original stroke;
merging and splitting any of said initial segments in response to said comparing to produce new segments; and
reclassifying each of said new segments as a type of primitive.

14. The memory device of claim 13 wherein said calculating the speed of drawing is performed using a finite difference approach.

15. The memory device of claim 13 wherein said calculating the curvature magnitude includes computing the derivative of the tangent angle with respect to arc length.

16. The memory device of claim 13 wherein said classifying and reclassifying includes using a least squares best fit.

17. The memory device of claim 13 wherein said identifying an initial set of candidate points includes the first and last points of the stroke.

18. The method of claim 13 wherein said splitting of said initial segments includes splitting segments at points in response to a measure of curvature sign.

19. A memory device carrying a set of instructions for performing a method of analyzing a symbol comprised of one or more drawn strokes, the method comprising:
calculating the speed of drawing along each stroke;
calculating a curvature magnitude along each stroke as the derivative of the tangent angle with respect to arc length;
identifying an initial set of candidate points defining initial segments using said calculated speed and curvature magnitude; and
classifying each initial segment as a type of primitive.

20. The memory device of claim 19 additionally comprising:
comparing said initial segments to said original stroke;
merging and splitting any of said initial segments in response to said comparing to produce new segments; and
reclassifying each of said new segments as a type of primitive.

21. The memory device of claim 19 wherein said calculating the speed of drawing is performed using a finite difference approach.

22. The memory device of claim 20 wherein said classifying and reclassifying include using a least squares best fit.

23. The memory device of claim 19 wherein said identifying an initial set of candidate points includes the first and last points of the stroke.

24. The method of claim 20 wherein said splitting of said initial segments includes splitting segments at points in response to a measure of curvature sign.
